(19) United States
(12) Patent Application Publication
(10) Pub. No.: US 2026/0366498 A1
(43) Pub. Date: Nov. 19, 2026

(54) INTEGRATED CHASSIS AND DISTRIBUTED KINEMATIC STABILIZATION SYSTEM

(71) Applicant: Surafel S Mamo, LYNNWOOD, WA (US)

(72) Inventor: Surafel S Mamo, LYNNWOOD, WA (US)

(73) Assignee: Hyperplane Technologies LLC, LYNNWOOD, WA (US)

(21) Appl. No.: 19/679,659

(22) Filed: May 16, 2026

Related U.S. Application Data
(60) Provisional application No. 63/808,053, filed on May 19, 2025.

(51) Int. Cl. F03G 3/08; B64G 1/24; B64G 1/28

(52) U.S. Cl. CPC F03G 3/083; B64G 1/285; B64G 1/242; F05B 2260/404; F05B 2270/502; F05B 2270/602; F05B 2270/80

(57) ABSTRACT

A kinematic stabilization node includes a monolithic multi-axis skeletal core having a primary linear actuation bore and secondary transverse bores. A dual-mass linear shifting assembly is disposed in the primary bore on opposite sides of a central pillar and is translated by electromagnetic coils. Momentum exchange flywheels are disposed in the secondary bores. An external magnetic coupling interface generates magnetic coupling forces relative to adjacent nodes. A spatial processing unit receives inertial-state data, determines a spatial deviation vector, actuates at least one flywheel to align the primary bore with the spatial deviation vector, translates the dual-mass linear shifting assembly, and modulates the external magnetic coupling interface so that an inertial force opposes a magnetic restoring-force component. Multiple nodes may be arranged in annular or stacked annular arrays.

### 1 CROSS-REFERENCE TO RELATED APPLICATIONS

This application claims the benefit of U.S. Provisional Application No. 63/808,053, filed on May 19, 2025, the entire contents of which are incorporated herein by reference.

### 2 FIELD OF THE DISCLOSURE

This invention relates to distributed industrial stabilization systems and high-density kinetic architectures. Specifically, it relates to an annular configuration utilizing an SE(2)-layered architecture to perform resonance-stabilized physical signal logic and structural harmonic variance mitigation.

### BACKGROUND

The proliferation of commercial low Earth orbit (LEO) mega-constellations has exponentially increased the risk of catastrophic orbital collisions, commonly known as the Kessler Syndrome. When a massive commercial satellite (e.g., exceeding 5,000 kg) experiences a critical failure, it becomes an inert, uncontrolled orbital mass. There exists an urgent commercial need for a distributed orbital infrastructure network that physically processes localized data at the edge to establish a synchronized geometric envelope configured to passively dampen external kinetic forces from uncontrolled orbital masses within nominal operational thresholds, rather than relying on abstract algorithmic weight-tuning.

### 3 SUMMARY

The present invention introduces a distributed kinematic array rooted in annular geometry, recursive mechanical transformation, and decentralized state convergence. Built upon stacked SE(2) transformation layers, the system enables stabilization through physical symmetry distribution rather than abstract algorithmic weight-tuning. The annular array exhibits emergent structural coherence by recursively cascading mechanical state corrections through its discrete nodes.

### BRIEF DESCRIPTION OF THE DRAWINGS

FIG. 1 Perspective view of the annular frame and stacked topology comprising a plurality of Kinematic Computational Nodes 100.

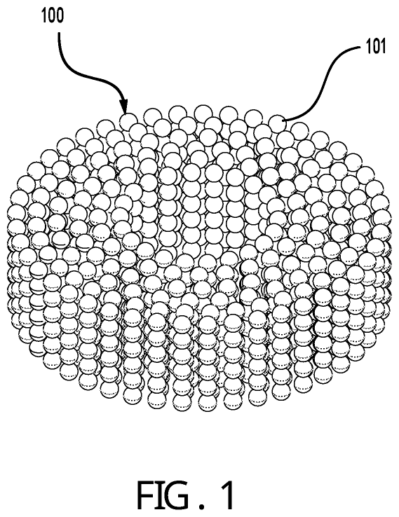

FIG. 2 Detail view of the Kinematic Computational Node 100 and internal Steinmetz Solid 110.

FIG. 3 Cross-sectional schematic of the Kinematic Computational Node 100, detailing the Momentum Exchange Flywheels 120 and Mass-Shifters 130.

FIG. 4 Equatorial cross-sectional schematic of the internal Steinmetz Solid core 110, Momentum Exchange Flywheels 120, and central pillar 135.

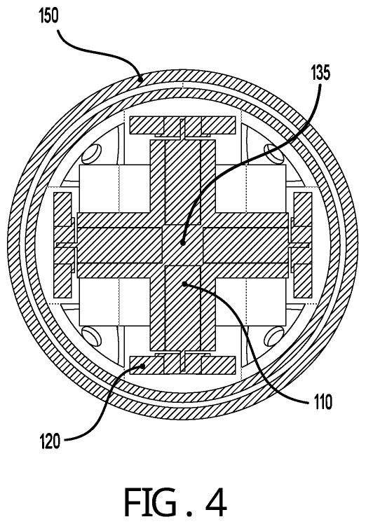

FIG. 5 Offset cross-sectional schematic detailing the Mass-Shifters 130 and the high-density PCB stack 140.

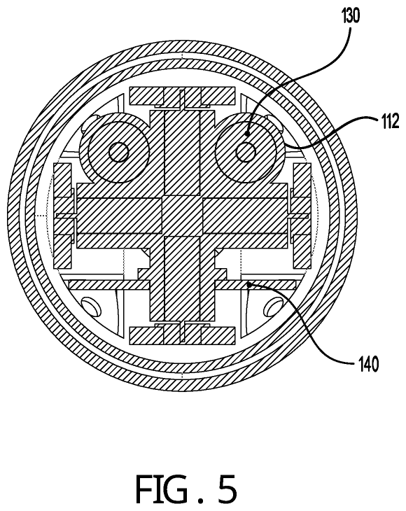

FIG. 6 Isolated perspective view of the central Steinmetz Solid 110, Mass-Shifters 130, and Momentum Exchange Flywheels.

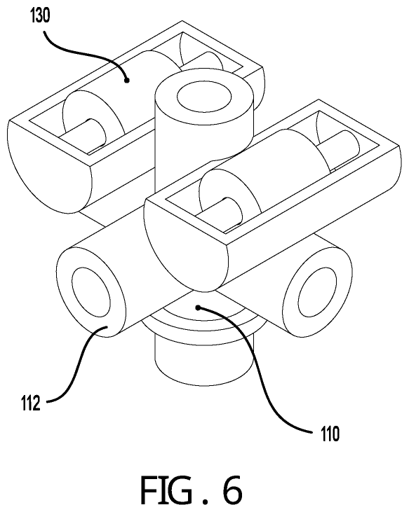

FIG. 7 Exploded structural view detailing the physical coupling interface between the internal skeletal core 110 and the high-density PCB stack 140.

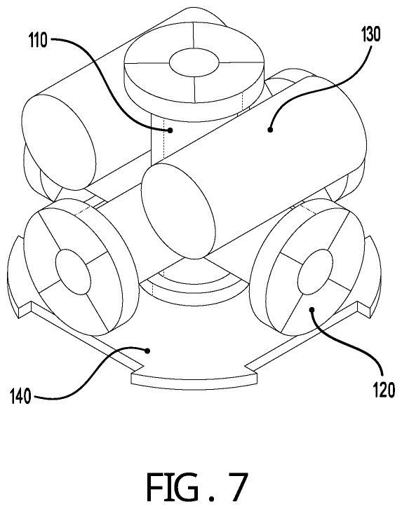

FIG. 8 Schematic block diagram mapping the interaction between the PCB Base 140 and the internal mechanical actuation assemblies.

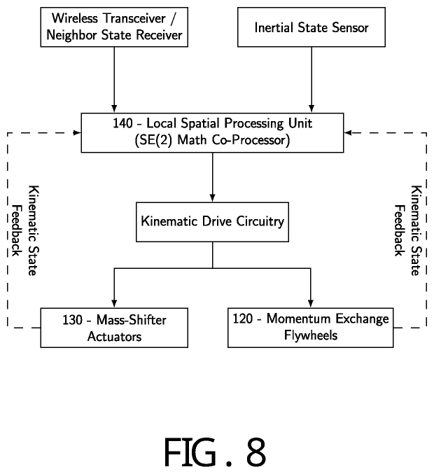

FIG. 9 Flowchart mapping the kinematic state convergence and asymptotic kinematic convergence logic loop.

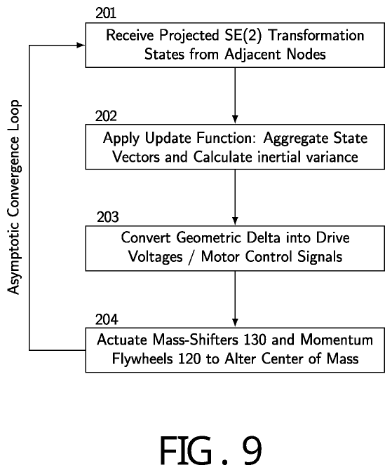

Ω (Omega): The computational domain composed of SE(2) annular layers. It serves as the underlying manifold for transformation and state cascading.
SE(2) Symmetry: The mathematical group of all 2D rigid body transformations, including rotations and translations. In this architecture, SE(2) governs how local transformations are computed and cascaded between neighboring nodes and across layers.
Asymptotic Kinematic Convergence: A continuous mechanical process by which a node dynamically refines its physical inertial state by resolving external kinetic variance against the projected spatial baseline of its neighbors, naturally dissipating harmonic stress over time.
Bijective Mapping: A one-to-one correspondence between transformed input and output ring layers under shared SE(2) operations. Ensures reversible cascading and lossless transformation fidelity.
Transverse Kinetic Attenuation: The lateral dissipation of kinetic dissonance across a single annular plane, where nodes exchange mechanical load data with neighbors to align their internal states.
Longitudinal Load Propagation: The vertical distribution of mechanical shear forces across adjacent stacked SE(2) layers, ensuring structural coherence of the total macroscopic volume.

### 4 DETAILED DESCRIPTION OF THE PREFERRED EMBODIMENTS

### The Kinematic Computational Node (Unit Cell Anatomy)

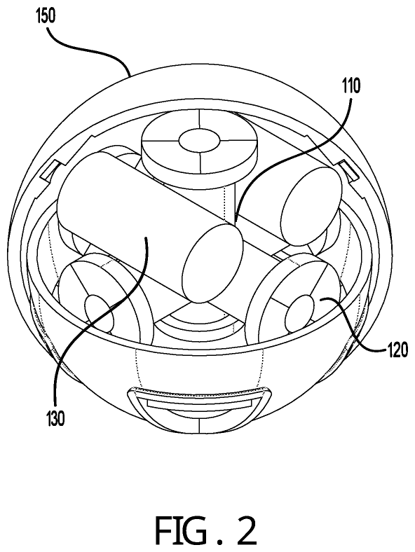

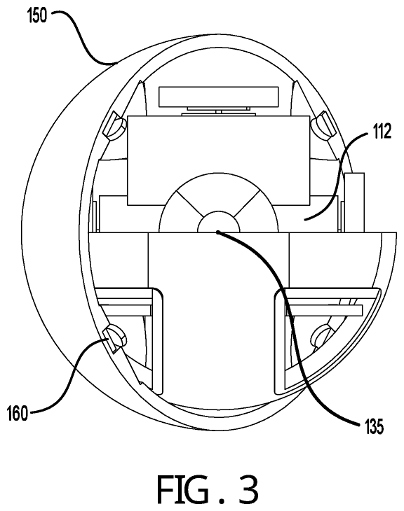

Referring to FIG. 2 and FIG. 3, the primary unit of the array is the Kinematic Computational Node 100. The Node 100 comprises a three-dimensional volumetric containment vessel containing a central Steinmetz Solid 110. The Steinmetz Solid 110 acts as a monolithic, highly rigid internal skeleton. Mounted to said Steinmetz Solid 110 are a plurality of dynamic mechanical elements, specifically Momentum Exchange Flywheels 120 and linear Mass-Shifters 130. Specifically, the linear Mass-Shifters 130 comprise a dual-mass linear shifting assembly housed within the primary linear actuation axis, wherein said assembly is bisected by a rigid central pillar to prevent internal kinetic collision.

The central skeletal core further comprises a rigid, flat-milled coupling interface located at a distal end of at least one of the orthogonal cylindrical volumes.

A high-density, multi-layer printed circuit board (PCB) stack 140—preferably comprising 6 to 12 or more routing layers—is physically coupled to this interface. Rather than relying on discrete, fragile standoffs that amplify kinetic shear, the PCB stack is affixed such that it acts as a unified kinetic mass with the monolithic core. Furthermore, the PCB stack incorporates integrated inductive telemetry and wireless power transfer architectures. To maintain operational continuity during transient spatial variance events that momentarily disrupt optimal inductive proximity, the PCB stack further comprises localized, high-density energy storage—such as solid-state micro-capacitors—configured to buffer kinematic drive voltages independent of the contiguous array. The entire internal assembly—comprising the Steinmetz Solid stator, the mass-shifting elements, and the integrated PCB stack is housed within a localized exterior containment shell, scaled in the preferred prototype embodiment to a roughly 70 mm volumetric footprint. This exterior containment shell further comprises an isotropic thermal radiation shell featuring a fractal array of surface-level micro-fins to maximize passive black-body radiation. The central skeletal core is thermally coupled to said shell via graphene-based high-conductivity internal pathways to passively dissipate internally generated electromagnetic heat into a surrounding vacuum environment, preventing localized thermal failure during intense kinetic dampening events. The internal assembly may be rigidly coupled to the interior of this shell, or alternatively, kinematically suspended within the shell to provide an additional layer of kinetic isolation. Because power and data are transferred inductively through the 70 mm boundary, the outer shell remains completely impenetrable to high-velocity micro-debris impacts encountered during distributed commercial debris mitigation.

The kinetic shearing forces generated by the internal mass-shifters are absorbed directly by the monolithic stator rather than propagating through discrete mechanical linkages or fragile PCB standoffs, effectively isolating the local spatial processing unit against high-G mechanical failure.

Furthermore, while the preferred orbital embodiment utilizes aerospace-grade metals and high-density kinetic alloys, the architecture is entirely scalable to terrestrial and rapid-prototyping environments. In an experimental or terrestrial testbed embodiment, the central skeletal core may be fabricated from high-rigidity thermoplastic polymers, photopolymer resins, or molded plastics. Correspondingly, the mass-shifting elements in such embodiments may comprise brass washers, copper alloys, or other functionally dense accessible materials. This material scalability ensures that the SE(2) kinematic logic functions identically regardless of the specific volumetric mass density of the selected manufacturing substrate.

While the preferred embodiment of the kinematic computational node is described and illustrated herein as having a substantially spherical geometry, it will be understood by those skilled in the art that the invention is not strictly limited to spheres. The containment structures and kinematic nodes may take the form of any three-dimensional geometry, including but not limited to cubes, tetrahedrons, dodecahedrons, other Platonic or Archimedean solids, cylinders, or irregular polyhedra, without departing from the scope and spirit of the claimed topological computations. However, while the exterior containment vessel may vary in geometry, the internal skeletal core must comprise an intersecting Steinmetz Solid geometry to permit orthogonal actuation of the linear mass-shifters.

### System Architecture and Physical Justification

The core architecture consists of an annular array of computing nodes arranged in a radial or toroidal configuration. Each node may be a microcontroller, quantum dot, nanosatellite, or fluid-bound module with sensing, processing, and communication capabilities. These nodes are spaced and interconnected such that their collective behavior is governed by local transformation rules defined within the SE(2) group.

Each node continuously performs two key functions: (1) receiving information from adjacent nodes in the ring, and (2) applying transformation functions that modify its internal state and propagate loads to the next layer or ring. These layers may be stacked vertically, simulating a column or ring-stack that allows transverse and longitudinal load propagation. Beyond a single ring, the architecture naturally extends to multiple concentric or parallel annular rings, each of which can serve as a specialized computational layer or functional region.

While the spatial processing unit may be embodied as a discrete symbolic logic controller, such as an ASIC or FPGA, the term ‘spatial processing unit’ as used herein also encompasses deterministic, non-digital mechanical feedback topologies. In a continuous kinetic embodiment, external spatial variance is resolved strictly through coupled kinematic resonance. In this configuration, the orthogonally aligned mass-shifting elements and momentum exchange flywheels act as a direct, mechanically coupled translation medium, dissipating external harmonic oscillations by naturally seeking a localized global minimum energy state (asymptotic physical equilibrium) exclusive of symbolic signal routing.

The annular geometry at the heart of this system is not an arbitrary design decision. It emerges naturally from the physical laws governing motion and stability in space. In astrophysical systems, particulate matter consistently self-organizes into ringlike formations because these are stable, low-energy configurations in curved spacetime. Gravitational fields created by a central mass give rise to equipotential orbital paths, making annular structures the most efficient and resilient formations for persistent, synchronized motion. The system leverages this same principle. Its ring of transformation aware computational nodes behaves not as an artificial scaffold, but as a native extension of orbital equilibrium.

### Magnetic Coupling and Dual-Domain Macro-Stabilization

In a further advanced embodiment, the kinematic computational nodes may optionally comprise a magnetic coupling interface, utilizing localized electromagnetic coils or permanent magnetic arrays positioned along the exterior of the containment vessel. In this configuration, the local processing unit is configured to calculate the spatial transformation state and concurrently output a primary drive signal to actuate the internal mass-shifting elements within the Steinmetz Solid core (altering local inertia), and a secondary drive signal to modulate the magnetic coupling interface (altering spatial proximity). By generating precisely controlled repulsive and attractive magnetic forces against adjacent nodes within the array, the simultaneous internal mass-shifting and external magnetic modulation kinematically locks the plurality of nodes into a rigidly stabilized, contiguous annular geometry. This dual-domain stabilization enables the emergent macro-structure to be maintained without reliance on physical tethers, rigid mechanical linkages, or conventional propulsive thrusters.

### Coordinated Internal and External Stabilization

In operation, the node coordinates rotational alignment, internal inertial actuation, and exterior magnetic coupling in a local control loop. The spatial processing unit first actuates one or more momentum exchange flywheels to orient the primary linear actuation axis relative to a sensed spatial deviation vector. The spatial processing unit then drives the electromagnetic coils to translate the first and second movable masses along the primary linear actuation axis. During this translation, the external magnetic coupling interface is modulated so that the inertial force generated by the moving masses opposes a magnetic restoring-force component between adjacent nodes.

This coordinated operation can reduce oscillatory motion that may arise when adjacent nodes are coupled primarily by magnetic attraction or repulsion. Because the internal mass translation and external magnetic coupling are controlled locally by the node, the system can reduce relative displacement between adjacent nodes without requiring a rigid mechanical tether.

### Mathematical Model and SE(2) Logic

The mathematical foundation of the architecture is built on the SE(2) group, which describes transformations involving two-dimensional rotation and translation. Each node in the system exists within a 2D annular layer and interacts with neighboring nodes by applying transformations and updating internal state vectors. These layers are vertically stacked, enabling multi-level computation through structural recursion.

The kinematic state resolution of the distributed array is governed by a localized coupled differential equation, defining the continuous mechanical feedback loop of the active node relative to its neighbor topology:

$${M}_{i} \frac{{d}^{2} {q}_{i}}{{dt}^{2}} + {C}_{i} \frac{{dq}_{i}}{dt} + {\sum }_{j ∈ {𝒩}_{i}} {K}_{ij} ( {q}_{i} - {q}_{j} ) = {F}_{ext}$$

Where qᵢ represents the full SE(2) kinematic state vector of the node (encompassing both translational position and rotational orientation), Mᵢ represents the generalized inertia tensor (encompassing both translational mass and the rotational moment of inertia), Cᵢ represents the generalized kinematic damping matrix, Kᵢⱼ represents the generalized restorative stiffness matrix (encompassing both linear magnetic tension and angular magnetic shear between adjacent nodes), and Fₑₓₜ represents the external spatial variance perturbation vector (encompassing both linear kinetic forces and angular torques).

This equation enables each node to perform asymptotic kinematic convergence, where it models not just its immediate configuration, but its expected change over time relative to others. The process evolves like a geometric kinematic relay but with spatial fidelity and transformation preservation.

### SE(2) Stack Interaction and Load Propagation

Each horizontal layer (SE(2) slice) is a 2D circular lattice. Layers are stacked vertically to form a 3D structural volume—an SE(2) stack. Within the stacked annular layers, kinetic dissonance is dissipated through structural load propagation. Transverse kinetic attenuation occurs laterally across a single annular plane, while longitudinal load propagation distributes the mechanical shear forces vertically across adjacent stacked layers, ensuring structural coherence of the total macroscopic volume. Each node exists in a specific SE(2) layer and contributes to a vertical load-bearing column, enabling mechanical state resolution across depth analogous to layered load distribution in cascaded physical arrays.

### Kinematic Actuation and Inertial Thresholds

The “nominal inter-node spatial baseline distance” is defined herein as the initial state distance established at orbital deployment (Time=0), dynamically anchored to the static, time-zero orbital deployment vector rather than a fluctuating localized gravitational field, providing an absolute mathematical constant for the variance calculation. To maintain structural viability during kinetic dampening events, the system is configured to limit spatial variance to strictly less than 1.5% of the nominal inter-node spatial baseline distance.

To execute the physical stabilization, the local spatial processing unit translates the geometric delta derived from the localized coupled differential equation into mechanical actuation. The calculated spatial error vector is fed into a localized Proportional-Integral-Derivative (PID) firmware controller. To reconcile the planar nature of the SE(2) geometric logic with the un-tethered 3D microgravity environment, this PID controller actively isolates and resolves localized out-of-plane (z-axis) kinetic perturbations, kinematically forcing the node back into strict alignment with the SE(2) computational plane. The controller then maps the required planar geometric shift to a corresponding Pulse Width Modulation (PWM) duty cycle, and these PWM signals are transmitted to the kinematic drive circuitry.

To survive the extreme internal kinetic shearing forces generated by rapid inertial modulation, the system eschews generic rotary motors and discrete linkages. Instead, the internal Steinmetz Solid core acts as a monolithic electromagnetic linear stator. The intersecting orthogonal cylindrical volumes are lined with electromagnet coils, and the high-density mass-shifting elements operate as magnetic shuttles gliding directly within the core. This monolithic stator architecture distributes the kinetic acceleration and deceleration loads evenly across the entire skeletal structure of the containment vessel, preventing localized PCB shearing and enabling highly rapid inertial counter-force generation without structural degradation.

To ensure the node possesses sufficient kinetic authority to physically alter its inertial trajectory without reliance on external chemical propellants, the internal mass-shifting elements are composed of high-density materials (e.g., tungsten). The system requires an operational mass ratio wherein the mass of the shifting elements relative to the total node mass (m_{shifter}/mₜₒₜₐₗ) is strictly ≥0.15. Furthermore, the mass-shifters actuate along a minimum internal radial throw-length equal to 40% of the internal Steinmetz core diameter. This specific mass-to-throw ratio guarantees that the kinetic momentum transfer exceeds the mechanical inertia of the containment vessel, successfully executing the calculated spatial correction.

### Bijective Mapping and Symmetry-Preserving Feedback

When both the input and output annular layers share the same global transformation (i.e., they remain equivariant under SE(2)), the system exhibits a bijective mapping. This allows for:
Reversible propagation
Error-resilient feedback
Recursive refinement of states
   Nodes kinematically align to project themselves forward in SE(2), compare expected structural states with returned physical loads, and adjust recursively, creating a continuous, self-organizing loop of mechanical load dissipation and inertial state-resolution.

### Signal Domains and Equivariance Framework

In alignment with geometric spatial formalisms, the architecture defines computation over a structured geometric domain Ω, which represents a continuous or discretized annular manifold composed of SE(2) slices. Each computational node μϵΩ carries a local signal state S_{μ}(t), and the transformation function ƒ satisfies the condition of equivariance:

ƒ(T·x)=T·ƒ(x),∀TϵSE(2) (1)

This ensures that stabilization is invariant to symmetry transformations—a foundational property in modern geometric kinematics theory. Transformations applied to nodes in Ω preserve the symmetry of the domain and the integrity of the information flow. This is supported by the SE(2) group axioms:
Associativity: (g·h)·ƒ=g·(h·ƒ)
Identity: ∃eϵG such that g·e=g
Inverse: ∃g⁻¹ϵG such that g·g⁻¹=e
Closure: ∀gϵG
   These axioms ensure that transformation sequences are structurally valid and reversible critical for symmetry-preserving convergence across layers.

### Node-Level Update Logic for Asymptotic Kinematic Convergence

To execute asymptotic kinematic convergence, the spatial processing unit continuously aggregates the projected spatial telemetry from adjacent nodes. It applies a distance-based attenuation matrix to this aggregated data to compute a localized geometric delta. This delta, representing the localized structural variance, is routed through a continuous hysteresis dampening filter to generate a targeted kinematic drive voltage, which physically actuates the mass-shifting elements to restore structural equilibrium.

In the digital ASIC embodiment, the spatial processing unit executes the asymptotic kinematic convergence via a continuous programmatic loop. First, the unit initializes a local state vector in SE(2). While the node is active, it receives neighbor states via inductive telemetry and computes a geometric delta for each neighbor. The unit applies a distance-attenuation weight and aggregates the total spatial error, Eₜₒₜₐₗ. This total spatial error is input into a localized PID controller, governed by the following discrete control equations:

P=Kₚ·Eₜₒₜₐₗ

I=KᵢΣ(Eₜₒₜₐₗ·Δt)

D=K_{d}·(ΔEₜₒₜₐₗ/Δt)

The final drive signal is the sum of the P, I, and D terms. The unit maps this drive signal to an orthogonal mass-shifter PWM duty cycle (0 to 255), actuates the internal stators, and updates the state vector based on the new inertial baseline.

Conversely, in the pure-kinematic analog embodiment, the spatial processing unit resolves the geometric delta as a continuous-time coupled electromechanical response. The physical motion of the internal mass-shifters and the induced magnetic tension act natively as a continuous PID feedback loop, inherently governed by continuous-time calculus where:

P=Kₚ·Eₜₒₜₐₗ(t)

I=Kᵢ∫Eₜₒₜₐₗ(t)dt

$$D = {K}_{d} \frac{{dE}_{total} ( t )}{dt}$$

In this analog modality, these terms are not calculated via digital clock cycles, but are resolved instantly and continuously through physical momentum, mechanical spring-tension, and continuous kinetic dampening. To operate exclusive of digital logic, the inertial state sensor comprises a purely analog piezoelectric harmonic oscillator. Furthermore, the self-generated inductive currents are routed to the external magnetic coupling interface via a passive, resonant LC tank circuit, wherein the mechanical displacement of the mass-shifters directly alters localized capacitance, dynamically routing phase-opposed currents without discrete logic gates.

To physically execute this continuous-time calculus without reliance on digital components, the continuous analog mechanical resonance topology utilizes highly specific structural geometries to natively instantiate the Proportional-Integral-Derivative (PID) feedback loop. First, to physically resolve the Proportional (P) term, the localized capacitance is defined by a variable dielectric gap directly actuated by a rigid sliding interlocking armature affixed to the dual-mass linear shifting assembly. This armature is physically tapered, ensuring that its linear mechanical displacement yields a strictly proportional voltage change within the passive LC tank circuit. Second, to physically isolate the Derivative (D) term, the dual-mass linear shifting assembly further comprises an induced Eddy current drag mechanism structurally tied to the tapered armature; this mechanism naturally resists velocity, isolating the derivative physical force of the spatial variance. Third, to physically resolve the Integral (I) term, the spatial processing unit incorporates a discrete capacitive charge-pump topology that physically accumulates mechanical displacement voltages over time. By mechanically binding these three physical structures directly to the inertial displacement of the mass-shifters, the architecture acts as a physical analog computer, perfectly mapping spatial error to phase-opposed inductive currents.

### Relation to Geometric Spatial Convergence

This invention utilizes established frameworks of geometric symmetry to achieve physical convergence over structured, symmetry-respecting domains. While traditional spatial modeling operates over theoretical graphs and manifolds, this system instantiates these principles in a physical ring-stack architecture.
Nodes act as mass-shifting kinematic agents
Layers are equivariant SE(2) slices
System convergence is defined not by symbolic computation, but by geometric transformation coherence
   This recursive geometric architecture provides a formal and testable basis for emergent physical stabilization, without reliance on centralized symbolic encodings. By grounding structural equilibrium in symmetry and transformation, the architecture enables a new category of spatial alignment one that emerges from motion-aware geometry.

### Comparison to Prior Art

To establish the novelty and non-obviousness of the system, it contrasts with closely related areas of research and engineering:
Distinction from Centralized Active Mass Dampers: It operates over a continuous or discretized annular manifold rather than arbitrary abstract topologies. It uses SE(2) group transformations as the core operational logic, not centralized matrix weight updates. Cascading is geometric and recursive, grounded in physical layout and transformation coherence, rather than relying on a single, centralized computerized pendulum.
Distinction from Centralized Processing Arrays: The system exhibits persistent state hysteresis through asymptotic kinematic convergence and threshold-controlled kinematic updates.
Distinction from Satellite Constellations: It proposes a computational architecture, not a communications network. It defines computation in the geometry itself—each node performs transformation-based logic.
Distinction from Biomimetic Gyroscopic Arrays: It is not biologically inspired; it is geometrically constructed. The system derives from symmetry-preserving transformation logic, not electrophysiological dynamics. Its nodes are kinematic agents whose behavior is defined by spatial configuration within a recursive annular geometry, avoiding biological mimics.

### Implementation Variants

The architecture may be instantiated through multiple practical implementations:
Orbital Micro-Satellite Rings: Deploy small satellites into annular orbits around a celestial body. Each satellite node contains onboard processors, SE(2)-aware logic, RF communication, and orientation sensors. Synchronization is achieved through inertial tracking and shared ephemeris data.
Fluid-Based Experimental Platforms: Construct a physical testbed using microcontrollers suspended in a fluid tank with low turbulence. Each node executes SE(2) operations locally and broadcasts transformation states.
Regolith-Bound Substrate Rings: Embed computing grains or printed circuit tiles into the regolith of small bodies. Nodes are solar-powered, dust-hardened, and wirelessly coupled.

### Physical Testbed and Analog Validation

A critical step toward validating the architecture lies in the use of physical kinematic testbeds rather than digital spatial simulation tools, as discrete-time virtual environments cannot accurately replicate continuous analog mechanical resonance. In one preferred implementation, scaled physical models of the Kinematic Computational Node are suspended within a low-friction, fluid-dynamic terrestrial environment. By subjecting the contiguous physical array to induced transverse shear forces, the continuous hysteresis dampening and SE(2) group symmetry convergence are empirically validated through direct mechanical observation.

### Terrestrial Kinematic Calibration

Prior to orbital deployment, the specific inertial damping coefficients and magnetic threshold limits of the spatial processing units are mechanically calibrated within a terrestrial fluid-dynamic or micro-gravity testbed. This physical baseline calibration establishes the foundational spring-tension parameters required for the array to achieve asymptotic equilibrium upon orbital insertion, without requiring active, external digital reconfiguration.

### Use Cases and Applications

The framework gives rise to a variety of applications across industrial domains:
Terrestrial Precision Manufacturing: The annular topology may be deployed to isolate extreme-ultraviolet (EUV) semiconductor lithography machines from ambient seismic and harmonic floor vibrations. By utilizing non-tethered physical kinematic consensus to maintain a strict geometric baseline, the array provides a zero-vibration focal perimeter for nanometer-scale civilian manufacturing.
Distributed Debris Mitigation and Kinematic Dampening: The distributed array may be deployed as a decentralized commercial satellite logistics network. Upon detection of uncontrolled high-inertia orbital refuse, the interconnected nodes calculate a local spatial transformation to dynamically shift internal mass, maximizing the localized magnetic repulsion field at the exact point of structural convergence, effectively mitigating harmonic kinetic energy during the kinetic dampening event to preserve structural integrity within nominal operational thresholds.
Deep-Space Scientific Relay Stabilization: The annular topology may be deployed to stabilize sensitive deep-space optical communication relays and interferometers. By utilizing non-tethered physical kinematic consensus to maintain a strict geometric baseline, the array provides a zero-vibration, continuously aligned focal perimeter for scientific instrumentation, highly resilient against the mechanical degradation typical of propellant-based orbital maintenance.
Decentralized Resource Extraction and Mining Operations: Systems are well-suited to perform closed-loop mining and material processing on asteroids and moons, adapting to irregular terrain without symbolic planning.
Distributed Orbital Kinematic Nodes: Closed-loop nodes deployed in orbit to perform scientific exploration and adaptive physical stabilization without Earth-based computation.
Environmental and Spatial Monitoring Arrays: Constellations orbiting a body continuously map its surface, magnetic fields, and dynamic behaviors, providing a persistent structural data mesh.

### Kinematic Mass-Scaling and Inertial Ratios

The stabilization capacity of the system scales strictly with the mass and orbital volume of its host body. The larger the gravitationally stabilized annular structure, the more nodes can be formed, maintained, and recursively integrated. Kinematic depth and recursive resolution increase as the mass of the host asteroid, moon, or planet increases.

While the invention has been described with reference to specific monolithic geometries, such as the Steinmetz Solid, it will be understood by those skilled in the art that various changes may be made, and functionally equivalent intersecting multiaxis geometries may be substituted, without departing from the absolute scope of the invention. The aforementioned manifestations are intended to be illustrative and not restrictive. The scope of the invention is defined entirely by the appended claims and their legal and structural equivalents.

It is expressly understood that the localized spatial processing unit may be instantiated in two distinct, alternative operational modalities to execute the spatial logic. In a first digital embodiment, the spatial processing unit comprises a bifurcated digital ASIC executing continuous algorithmic control loops. In a second alternative pure-kinematic embodiment, the spatial processing unit comprises a continuous analog mechanical resonance topology, resolving spatial variance strictly through physical displacement exclusive of symbolic digital logic.

What is claimed is:

1. A monolithic multi-axis kinematic stabilization node, comprising: a central skeletal core having a primary linear actuation cylindrical bore extending along a first axis and a plurality of secondary cylindrical bores extending along respective axes transverse to the first axis; a dual-mass linear shifting assembly housed within the primary linear actuation cylindrical bore, wherein the dual-mass linear shifting assembly comprises a first movable mass and a second movable mass positioned on opposite sides of a rigid central pillar; a plurality of electromagnetic coils disposed along an interior of the primary linear actuation cylindrical bore and configured to translate the first movable mass and the second movable mass relative to the rigid central pillar; a plurality of momentum exchange flywheels housed within the secondary cylindrical bores; an inertial state sensor configured to generate inertial-state data corresponding to motion of the node; an external magnetic coupling interface disposed along an exterior boundary of the node and configured to generate a magnetic coupling force relative to an adjacent node; and a spatial processing unit operatively coupled to the inertial state sensor, the electromagnetic coils, the momentum exchange flywheels, and the external magnetic coupling interface, wherein the spatial processing unit is configured to: exchange spatial telemetry with the adjacent node via the wireless spatial telemetry transceiver; receive the inertial-state data from the inertial state sensor; determine a spatial deviation vector associated with displacement of the node relative to a nominal spatial baseline; actuate at least one of the momentum exchange flywheels to rotationally align the first axis with a component of the spatial deviation vector; actuate the electromagnetic coils to translate the first movable mass and the second movable mass in opposite directions along the first axis; and modulate the external magnetic coupling interface while translating the first and second movable masses so that an inertial force generated by translation of the first and second movable masses opposes a magnetic restoring-force component between the node and the adjacent node.

2. The kinematic stabilization node of claim 1, wherein the spatial processing unit comprises an analog controller including a passive resonant LC tank circuit and a variable capacitor, wherein a capacitance of the variable capacitor changes in response to displacement of the dual-mass linear shifting assembly.

3. The kinematic stabilization node of claim 2, wherein the variable capacitor comprises a tapered sliding armature configured to produce a monotonic capacitance change as the dual-mass linear shifting assembly moves along the first axis.

4. The kinematic stabilization node of claim 3, further comprising an eddy-current damping element mechanically coupled to the tapered sliding armature and configured to generate a drag force responsive to velocity of the dual-mass linear shifting assembly.

5. The kinematic stabilization node of claim 2, wherein the inertial state sensor comprises a piezoelectric sensor configured to generate an analog signal supplied to the passive resonant LC tank circuit.

6. The kinematic stabilization node of claim 1, wherein the spatial processing unit comprises an application-specific integrated circuit configured to determine the spatial deviation vector and generate drive signals for the electromagnetic coils, the momentum exchange flywheels, and the external magnetic coupling interface.

7. The kinematic stabilization node of claim 1, wherein the dual-mass linear shifting assembly represents at least 15% of a total mass of the node, and wherein the primary linear actuation cylindrical bore provides a linear travel distance equal to at least 40% of a diameter of the central skeletal core.

8. A distributed kinematic stabilization array, comprising: a plurality of kinematic stabilization nodes according to claim 1 arranged in an annular topology, wherein each kinematic stabilization node is configured to exchange spatial telemetry with at least two adjacent kinematic stabilization nodes, wherein the external magnetic coupling interfaces of adjacent kinematic stabilization nodes are configured to generate adjustable magnetic coupling forces between adjacent nodes, and wherein the spatial processing units of the plurality of kinematic stabilization nodes are configured to execute a local stabilization sequence comprising: rotationally aligning the first axis of a corresponding node with a component of a spatial deviation vector; translating the first movable mass and the second movable mass of the corresponding node in opposite directions along the first axis; and modulating the external magnetic coupling interface of the corresponding node during the translating step to reduce relative displacement between adjacent nodes from a nominal annular baseline.

9. A multi-layered distributed kinematic stabilization system, comprising: a plurality of annular layers arranged along a stacking axis, wherein each annular layer comprises a distributed kinematic stabilization array according to claim 8, wherein the spatial processing units of the kinematic stabilization nodes in each annular layer are configured to reduce in-plane relative displacement between adjacent nodes within the annular layer, and wherein the spatial processing units of kinematic stabilization nodes in adjacent annular layers are configured to exchange spatial telemetry to reduce inter-layer displacement along the stacking axis.
